(19) United States
(12) Patent Application Publication
(10) Pub. No.: US 2016/0334070 A1
(43) Pub. Date: Nov. 17, 2016

(54) LIGHTING DEVICE HAVING A SOLAR PANEL

(71) Applicants: Jason Young Cho, Livingston, NJ (US); Kim Jong Sun, Sungnam-City (KR)

(72) Inventors: Jason Young Cho, Livingston, NJ (US); Kim Jong Sun, Sungnam-City (KR)

(21) Appl. No.: 14/711,094

(22) Filed: May 13, 2015

(51) Int. Cl. F21S 9/03; F21V 21/32; F21V 17/06; F21S 6/00; F21V 23/04

(52) U.S. Cl. CPC F21S 9/035; F21S 6/00; F21V 23/0464; F21V 17/06; F21V 21/32

(57) ABSTRACT

A solar lighting device, disclosed herein, comprises a solar cell assembly, attached to an elongated lighting device holder through an attachment assembly which can be rotated to provide an orientation of the solar panel so as to harvest more sun light.

### TECHNICAL FIELD

The present invention is in the field of solar powered lighting devices. Specifically, the invention relates to a solar powered device, which provides low cost lighting to people with sufficient sunshine to provide long day-light periods, particularly to people with unreliable access to electric power sources.

### BACKGROUND OF THE INVENTION

Solar energy is believed to be a green energy and clean energy alternative for oil and gas. However, as it stands today, it only represents a tiny portion of the total energy used in the United States. Until recently, with the technology advancements in photovoltaic cell efficiency and the high-output and low-cost manufacturing processes available, more and more photovoltaic powered consumer goods have become commercially available.

One challenging aspect of using solar cells to power consumer electronics, is the available hours of daylight time. For example, with the efficiency of the current silicon based solar cells, it still requires about 5 to 8 hours of direct sunlight to charge a battery in order to power a lighting device. Many places do not have that length of sunlight hours throughout the year. Even for the places that do seem to have plenty of daylight, the current use of solar cell powered consumer goods are limited only to outdoor applications, such as, for example, for powering signage or traffic lights.

A second challenging aspect of using a solar cell to power consumer electronics, is that the direction of sunlight changes throughout the day, whereas most of solar cells are fixed on a non-movable surface of the consumer good. Therefore even though there is plenty of sunlight for 8 hours, in the indoors or in an open space, the solar cell operates with the most optimal amount of the incoming light only a portion of the time, and therefore only a portion of the light can be harvested by the solar cell due to the incident angle of the incoming light.

A third challenging aspect of the solar-powered consumer products is that attaching a photovoltaic cell directly onto a surface of a consumer product is not aesthetically appealing.

Therefore, there is a need to develop solar cell-powered products, which can maximize the sunlight's harvest efficiency, in particular when used indoors and the products are aesthetically acceptable to a consumer.

### SUMMARY OF THE INVENTION

The solar lighting device, disclosed in the present invention, comprises a lighting device holder; a solar panel; a rechargeable battery; LED lights; and a circuit board. Comparing the solar lighting device in the present invention with other solar lighting devices found in the market place, the solar lighting device of the present invention is more elegantly designed. Further, the solar lighting device of the present invention comprises an attachment assembly, which can maximize the light harvesting of the solar panel throughout the day by adjusting the orientation of the solar panel through changing postures of the attachment assembly in accordance with the direction of the incoming sunlight.

A primary object of the present invention is to provide a standalone lighting device. Further the standalone solar lighting device is one that only uses solar power without any other additional source of electricity.

It is another object of the present invention to provide a solar lighting device where the orientation of the solar panel can be easily adjusted in accordance with the direction of incoming sunlight so as to maximize solar light harvesting. Further the change in orientation is a simple and easy operation which can be easily carried out by the average person.

It is yet another object of the present invention, to provide a solar lighting device that can be easily installed by the average person.

It is still another object of the present invention, to provide a solar lighting device wherein the device can turned on and off by a brightness sensor.

In one aspect, the present invention describes an improved structural design for a solar lighting device, which comprises a housing, comprised of an elongated lighting device holder and a cover for a plurality of LEDs; a solar cell assembly, attached to the elongated holder through an attachment assembly. The solar cell assembly comprises a solar panel situated on a top surface of the solar cell assembly and an attachment assembly configured to adjust the orientation of the solar panel to harvest more sunlight by changing a pasture of the attachment assembly and wherein the pasture of the attachment assembly is changed by rotation.

Further, the attachment assembly comprises a fastening nut wherein one portion of the fastening nut is embedded in the bottom surface of the solar cell assembly and the other portion of the fastening nut is exposed outside of the bottom surface of the solar cell assembly; a fastening bolt, configured to be a mating partner with the fastening nut, comprising a first part and a second part wherein the first part and second part of the fastening bolt are separated by a fastening gap; and a retaining member, having a ball shaped first end. When the fastening gap is reduced, the ball shaped end of the retaining member is maintained in the fastening bolt by a static pressure in a locked position; and whereas when the fastening gap is not reduced, the ball shaped end of the retaining member can rotate within fastening bolt in an unlocked position.

In another aspect, the present invention describes a method to use a solar lighting device. The method comprises providing a solar panel locked in one orientation; adjusting the orientation of the solar panel in accordance with a direction of sunlight, comprising touching a top surface of the solar panel to rotate the solar panel counter clockwise to open a lock; and touching the top surface of the solar panel to rotate the solar panel clockwise to fasten the lock.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a left side perspective view of an exemplary solar lighting device in accordance with the present invention;

FIG. 2 is a left side perspective view of another exemplary solar lighting device in accordance with the present invention;

FIG. 3 is a picture of an exemplary solar lighting device in accordance with the present invention;

FIG. 4 is a detailed view of an exemplar attachment assembly and its attachment position at the solar lighting device holder as shown in FIG. 1;

FIG. 5 is an illustration to show the exemplary solar lighting device mounted to a side wall;

FIG. 6 is a side view of the solar cell assembly and attachment assembly as shown in FIG. 2;

FIG. 7 is a top view of the solar cell assembly of FIG. 3;

FIG. 8 is a bottom view of the solar cell assembly of FIG. 3;

FIG. 9 is a cross section view of the solar cell assembly of FIG. 3;

FIG. 10 is a schematic illustration of the solar cell assembly and LED assembly;

FIG. 11 is an illustration of a first exemplary pasture of the attachment assembly;

FIG. 12 is an illustration of a first exemplary orientation of the solar cell assembly when the attachment assembly adopts its first pasture;

FIGS. 13 and 14 are illustrations of the different pastures of the attachment assembly;

FIG. 15 is an illustration of a second exemplary pasture of the attachment assembly;

FIG. 16 is an illustration of a second exemplary orientation of the solar cell assembly when the attachment assembly adopts its first pasture;

FIG. 17 is a front view of the attachment assembly;

FIG. 18 is a front view of the nut;

FIG. 19a is a top view of the bolt;

FIG. 19b is a front and exploded view of the bolt;

FIG. 20 is a bottom perspective view of the bolt and retaining member;

FIG. 21 is a top perspective view of the bolt and retaining member; and

FIG. 22 is a front perspective view of the retaining member.

### DETAILED DESCRIPTION OF EXAMPLE EMBODIMENTS

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents that can be included within the spirit and scope of the described embodiments as defined by the appended claims.

In the scope of the present invention, sometimes, the solar lighting device is also referred as a solar lamp. In the scope of the present invention, sometimes, the solar cell assembly is also referred to as a solar disk.

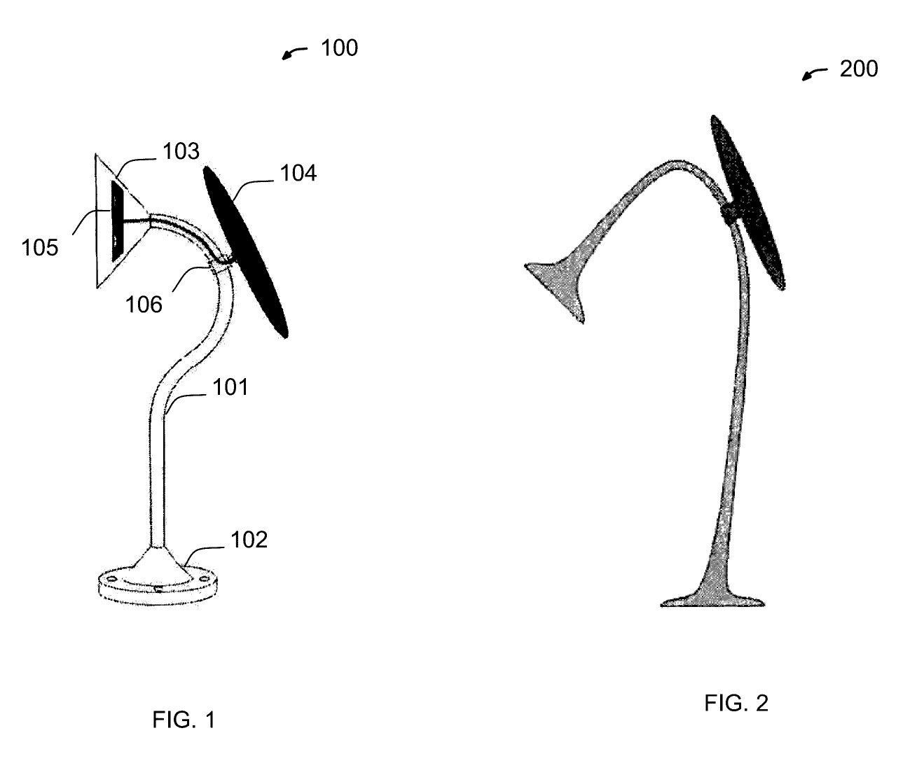

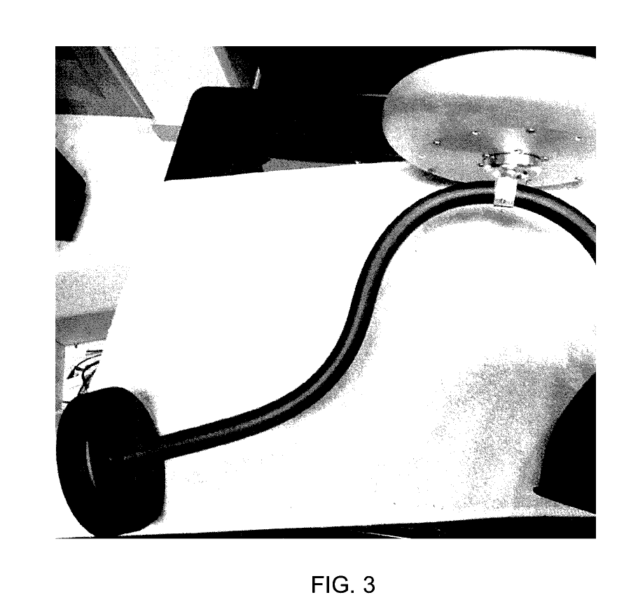

In the scope of the present invention, referring to FIGS. 1-3, a solar lighting device (100 and 200) is described. The solar lighting device comprises a housing, a solar cell assembly 104, the solar cell assembly 104 is connected to the housing through an attachment assembly 106. The housing of the solar lighting device comprises an elongated lighting device holder 101, one end is connected to a cover (103) for a plurality of LEDs (105), and the other end is connected to a base 102. In one embodiment of the present invention, the housing of the lamp is transparent. In another embodiment of the present invention, the housing of the lamp is not transparent. In the accordance with the aspects of the present invention, any material can be used to make the housing for the lamp as long as the material is mechanically strong enough. In the preferred embodiments, as shown in the FIGS. 2, 4 and 5, the housing including the lamp holder 101, lamp base 102 and cover for the LEDs 103 are made of metal or metal alloys.

### The Base and Mounting Surface

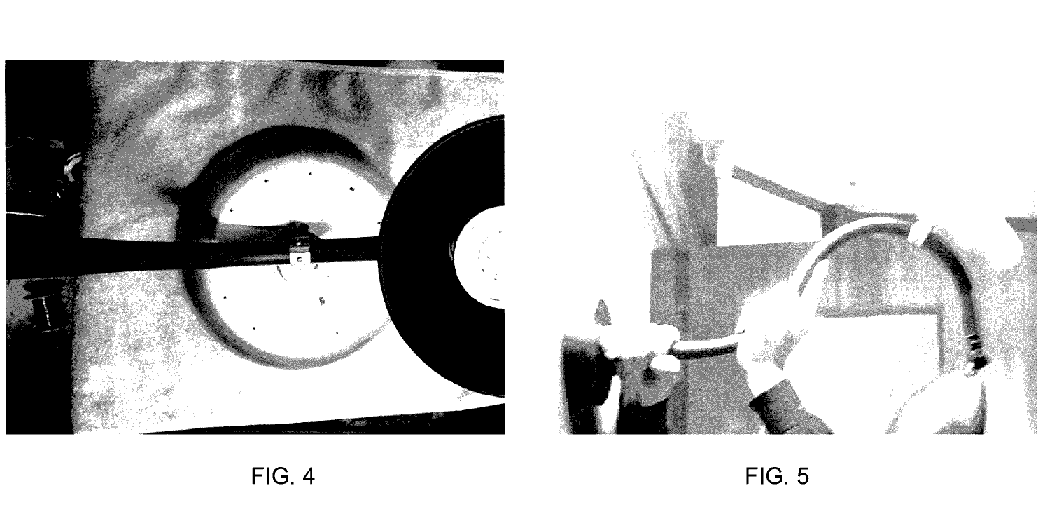

In some embodiments, the base 102 as shown in FIGS. 1 and 4, are flat and can be mounted onto any flat surface. For example, the base can be secured to a flat table or a sidewall of a room. In other embodiments, the base can conform to the surfaces, which are mounted onto the base 102 and which surfaces are not necessarily flat.

### Holder and Solar Disk

Referring to FIGS. 1 and 2, the solar lighting device is elegantly designed and the elongated lamp holder 101 substantially resembles a goose neck. The lamp holder 101 has a curved portion, for example a tope, and a straight portion, extended to the base 102 of the lamp.

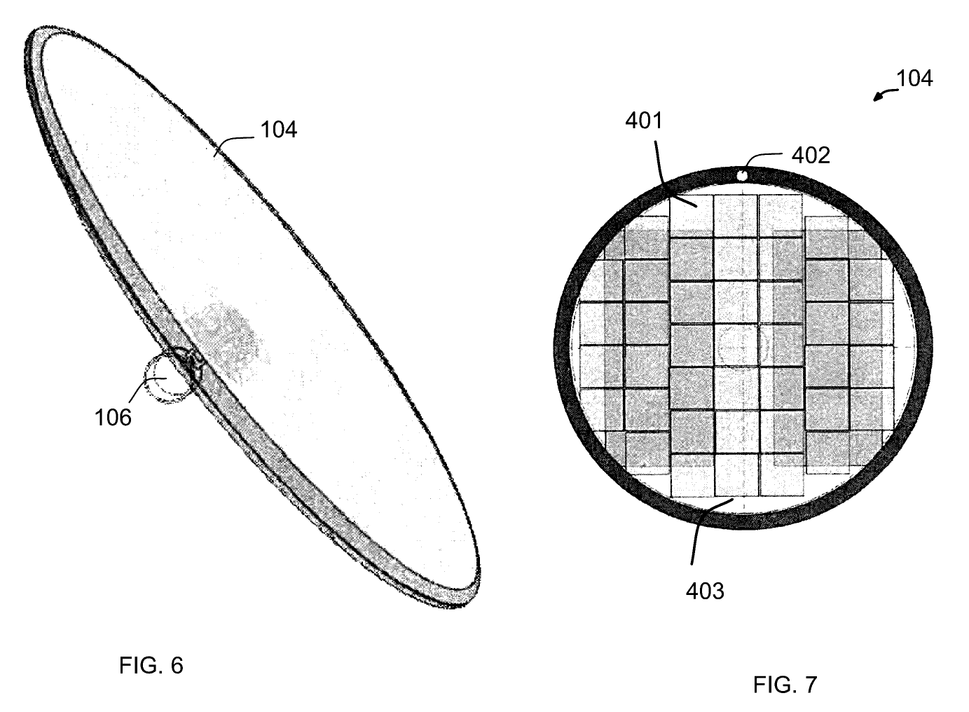

A solar cell assembly 104, having a solar panel 401 situated on a top surface of the solar cell assembly, is attached to the elongated lamp holder 101. In some embodiments, as the side views of the solar cell assembly show, the solar cell assembly is substantially in the shape of a dome or a half of a bagel, having a flat top surface and a curved bottom surface. In some other embodiments, the solar cell assembly is in a shape resembling a slice of a cylinder, having both the top and bottom surfaces flat and two sides curved. Further as shown in FIGS. 6-10, the top and bottom surfaces are round. Specifically, as illustrated by FIG. 6, the top surface of the solar assembly comprises a series of solar panels 401. The solar panels 401 are rectangular or square shaped and are arranged in rows and columns. The space between the solar panels is comprised of solar window glass 403. In one example, the solar window glass 403 is the same as the substrate for the solar panels 401, in other words the solar panels were made in assigned positions. In another example, the solar panels 401 were made first and deposited onto the solar window glass 403 in assigned positions afterwards.

In accordance with the aspects of the present invention, any material can be made suitable as the enclosure for the solar cell assembly. In one example, as shown in FIG. 7, the top surface of the solar cell assembly is a solar panel on a glass substrate, therefore the top surface comprises a glass. In another example, if the solar panel has a plastic substrate, then the top surface of the solar cell assembly comprises a plastic material. In another example, the bottom and curved sides of the solar cell assembly are made of one piece of metal or metal alloy.

When the solar cell assembly is made of glass and metal enclosures, the weight of the assembly become significant for the solar lamp holder 101 and lamp base 102. In order to balance the weight of the solar cell assembly, including the weight of the attachment assembly, it is preferred that the solar cell assembly is attached to a curved portion of the elongated holder of the lamp holder 101. In one example, as illustrated in FIGS. 1-3, the solar cell assembly is attached to the top of the lamp holder, wherein the attachment assembly is fixed to the lamp holder at the top of the lamp holder 101.

### Stand Alone Device

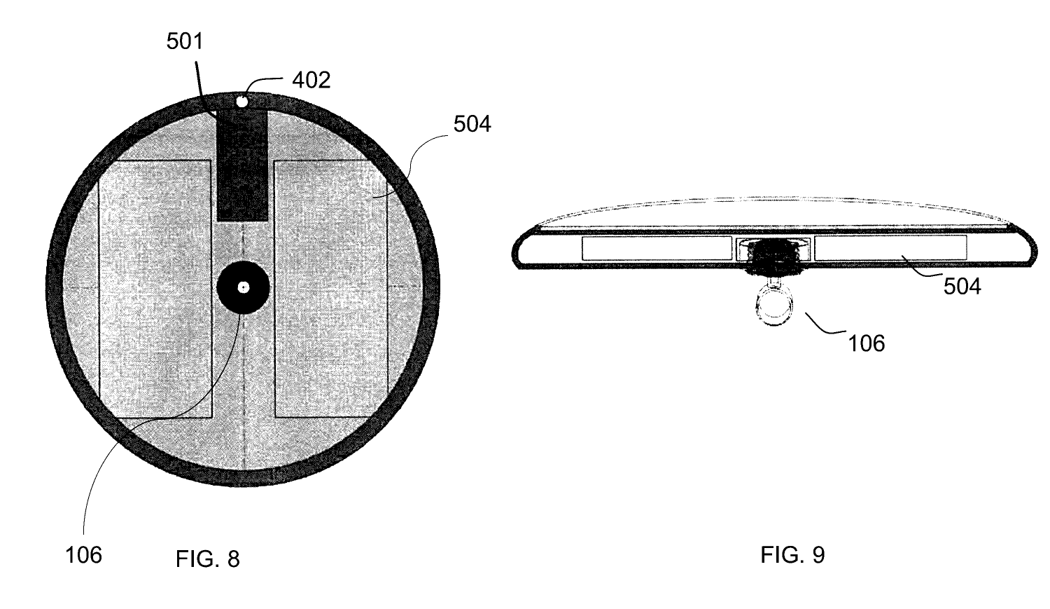

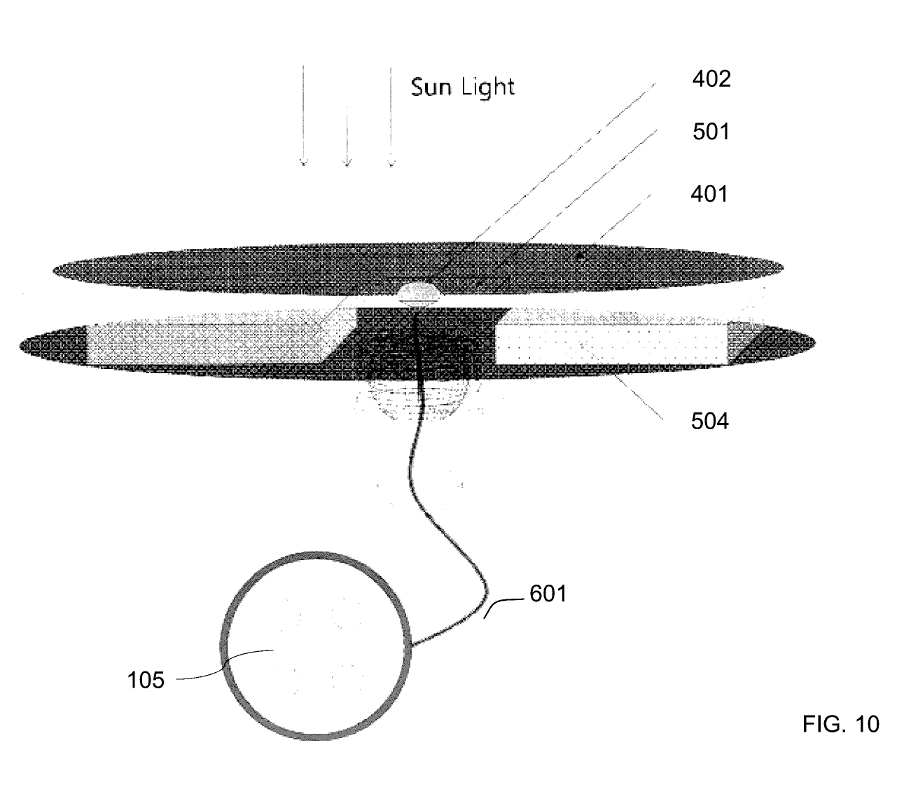

As shown in FIGS. 1-3, the solar lighting device as shown is a standalone and self-sustained solar device, which is not connected to any other power supply or lighting devices. As the bottom view of the solar cell assembly in FIG. 8 shows, the solar cell assembly further comprises a control circuit board 501 and rechargeable battery 504. As shown in FIGS. 5, 13 and 14, the control circuit board 501 and rechargeable battery 504, or other elements that are not shown, are enclosed in the solar cell assembly and sandwiched between the top and bottom surfaces of the solar cell assembly. The solar panel 401 takes up sunlight, converts the same to electrons in order to charge to the rechargeable batteries 504, and the rechargeable batteries 502 provide power to the LEDs. As further shown in FIG. 10, the control circuit board 501 and/or the rechargeable battery 504 connected to the LEDs through electrical wires going through the attachment assembly. As further shown in FIGS. 8 and 9, the solar cell assembly may comprise one or more rechargeable batteries, arranged in two or more separate battery packages. In such an example, preferably, the batteries are arranged in rows or in series within one package, different battery packages are then placed across the center of the solar cell assembly in order to engineer the weight center of the solar cell assembly to be closer to or not too far away from the geometric center or volume center of the solar cell assembly. In another example, the batteries can be arranged around the center of the solar cell assembly to presumably evenly distribute the weight of the batteries across the solar cell assembly.

### Brightness Sensor

Additionally, the solar cell assembly comprises a brightness sensor, detecting the brightness of the environment that the solar lamp is placed in and sending the information to the control circuit. According to the brightness of the environment, the control circuit will send out instructions to open or close the power supply circuits to the LEDs 105. By doing so, the LEDs units 105 can be automatically turned on or off depending on the brightness of the surrounding environment. In one aspect of the present invention, in one embodiment, the brightness sensor 402 is placed on the top surface of the solar cell assembly. In one example, as shown in FIGS. 7 and 8, the brightness sensor 402 is located on an edge or a periphery of the solar cell assembly. In another example, the brightness sensor 402 is placed in close proximity to the control circuit board 501.

### Attachment Assembly

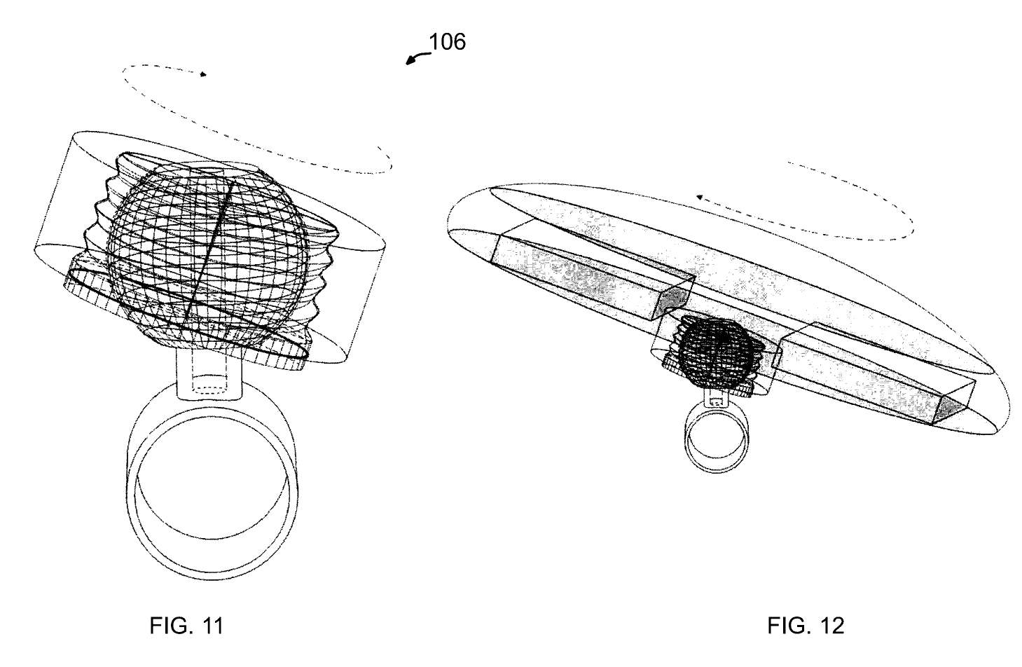

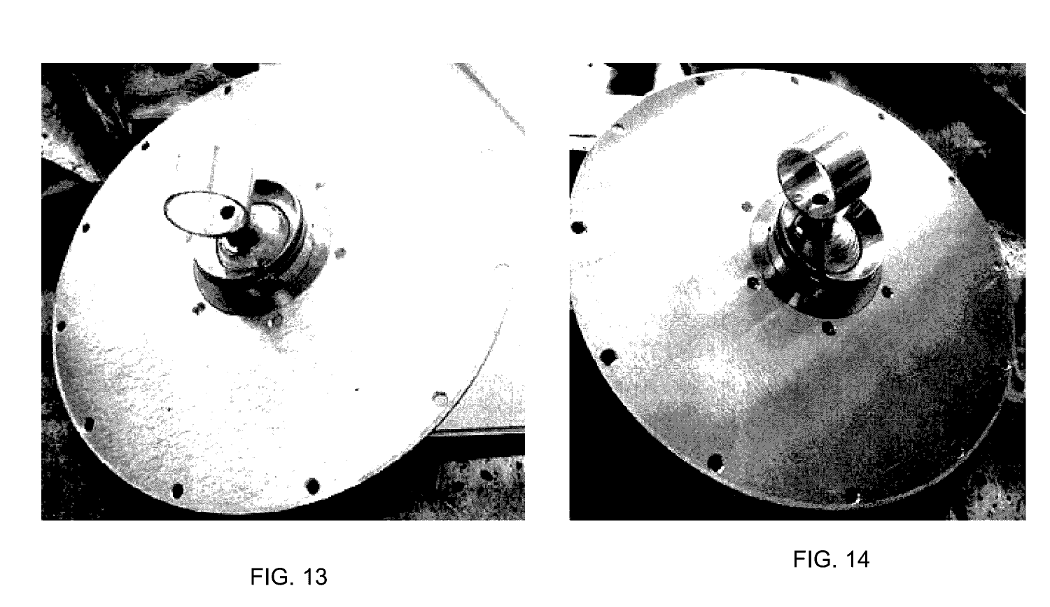

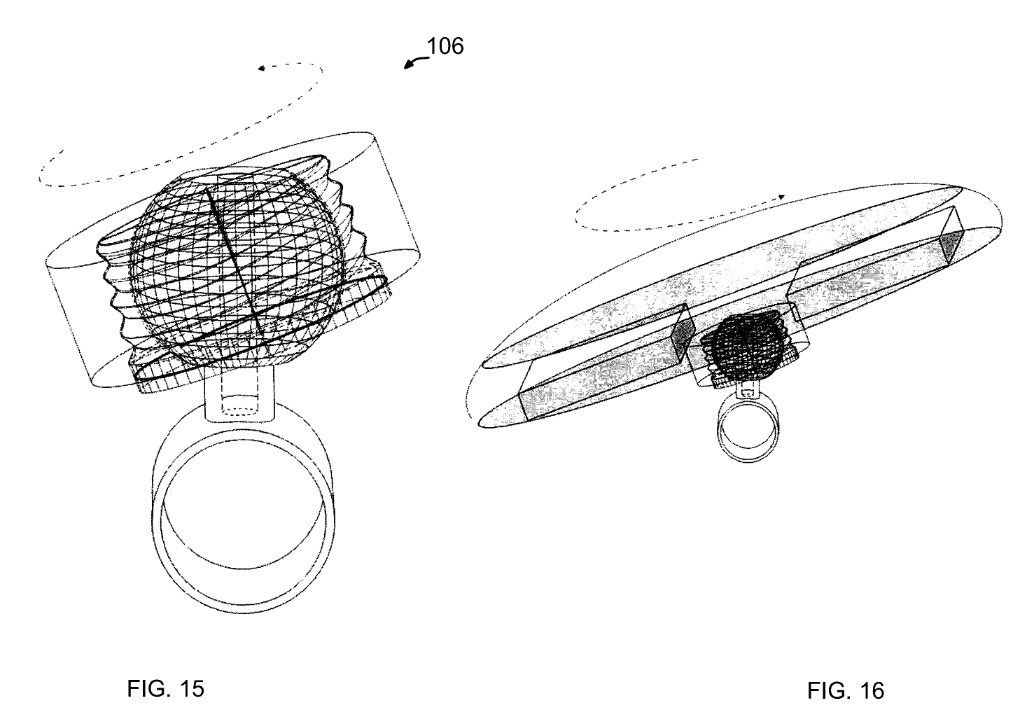

The present invention as disclosed herein is directed to a solar lighting device having a solar cell assembly wherein the solar cell assembly can adjust its orientation in accordance with the direction of incoming sunlight while still being fixed on the holder 101 of the solar lighting device. The solar cell assembly is attached to the lamp holder 101 through an attachment assembly 106. The solar cell assembly changes its orientation in accordance with the pasture changes of the attachment assembly 106. FIGS. 11 and 12 shows, when the attachment assembly 106 adopts a first pasture, the solar cell assembly takes to a first orientation. And the attachment assembly 106 adopts a second pasture, then the solar cell assembly takes a second orientation, as in FIGS. 15 and 16. Comparing FIGS. 12 and 16 with FIG. 13, when the solar cell assembly takes either the first or second orientations, the attachment assembly 106 is not in an upright position with respect to the first surface of the solar cell assembly.

Referring to FIGS. 3 and 10, one end of the attachment assembly 106 is fixed onto the lamp holder 101 and the other end of the attachment assembly 106 is partially embedded in the bottom surface of the solar cell assembly. In one embodiment, as shown in FIGS. 7, 9 and 10, the attachment assembly 106 is positioned at the geometric or volume center of the attachment assembly 106. In one example, the geometry center coincides with the weight center of the attachment assembly 106, and the attachment assembly 106 is positioned at the weight center of the solar cell assembly.

Referring to FIG. 10, the attachment assembly 106 comprises a first end, a second end and a connecting member between the first end and a second end, wherein a portion of the first end is embedded or hidden under the bottom surface of the solar cell assembly and the second end and the connecting member is exposed outside of the solar cell assembly.

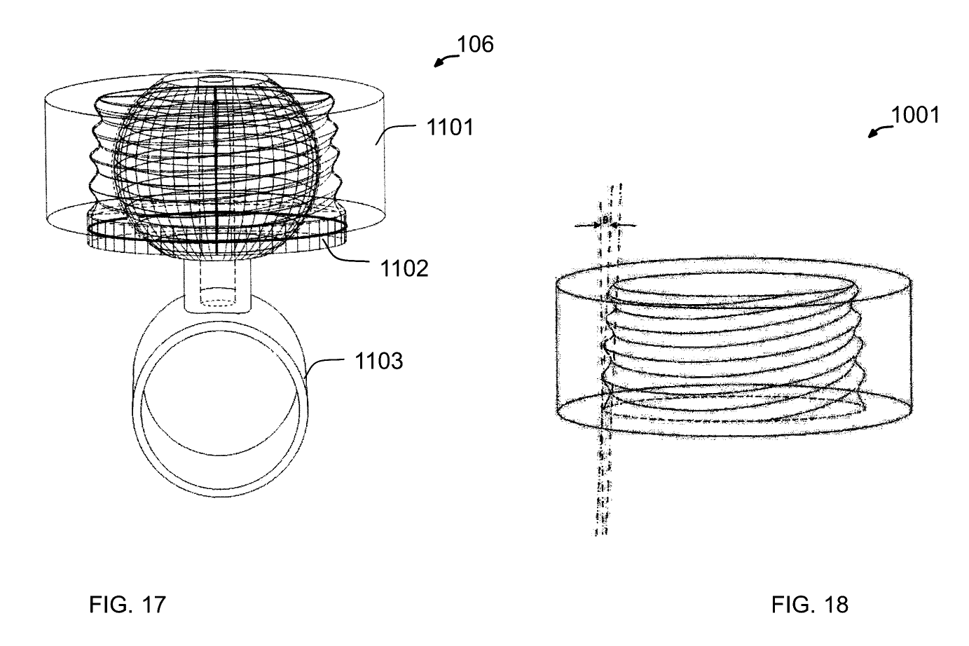

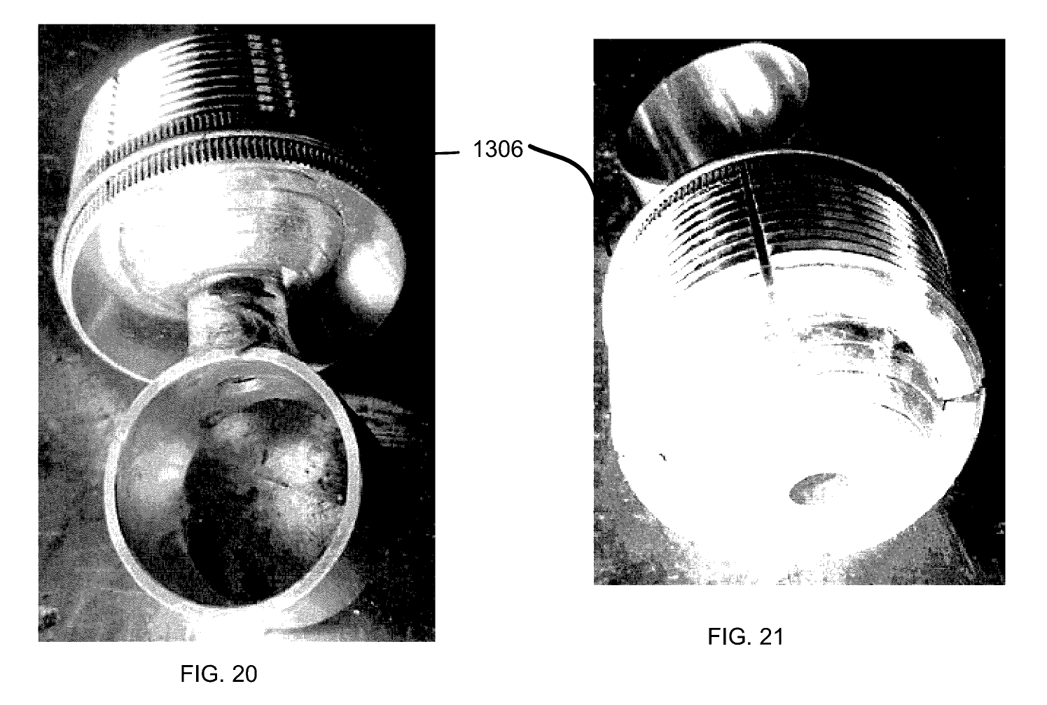

FIGS. 17-21 depict detail structure illustration of the exemplary attachment assembly in accordance with the aspect with the present invention. As shown in FIG. 17, the attachment assembly 106 comprises a fastening nut 1101, a fastening bolt 1102 as a mating partner with the fastening nut 1101 and a retaining member 1103. The fastening bolt 1102 is configured to a mated partner with the fastening nut 1101 and a first end of the retaining member 1103 is configured to be fit into the hole of the fastening nut 1101 while still able to accommodate the fastening bolt 1102.

Referring to FIG. 18, the fastening nut 1101 has an inside thread. The thread has an inclination angle of θ. And preferably, the inclination angle of θ is between xx-yy degrees. As shown in pictures (FIGS. 13 and 14), a portion of the fastening nut 1101 is exposed outside of the bottom surface of the solar cell assembly. The shape of the nut shown in FIG. 18 is a round nut, but other shapes of the nut are also possible. In one example, the center of fastening nut 1101 coincide with a geometry center of a slice of the solar cell assembly. In another example, the center of the fastening nut 1101 coincides with a weight center of a slice of the solar cell assembly. Referring to prototype pictures (FIGS. 13 and 14), the height direction of the nut 1101 is perpendicular to flat surface of the top or bottom surface of the solar cell assembly. When the attachment assembly 106 is placed inside of the solar cell assembly, one portion of the fastening nut 1101 along its height direction is embedded in the bottom surface of the solar cell assembly and the other portion of the fastening nut 1101 is exposed outside of the bottom surface of the solar cell assembly.

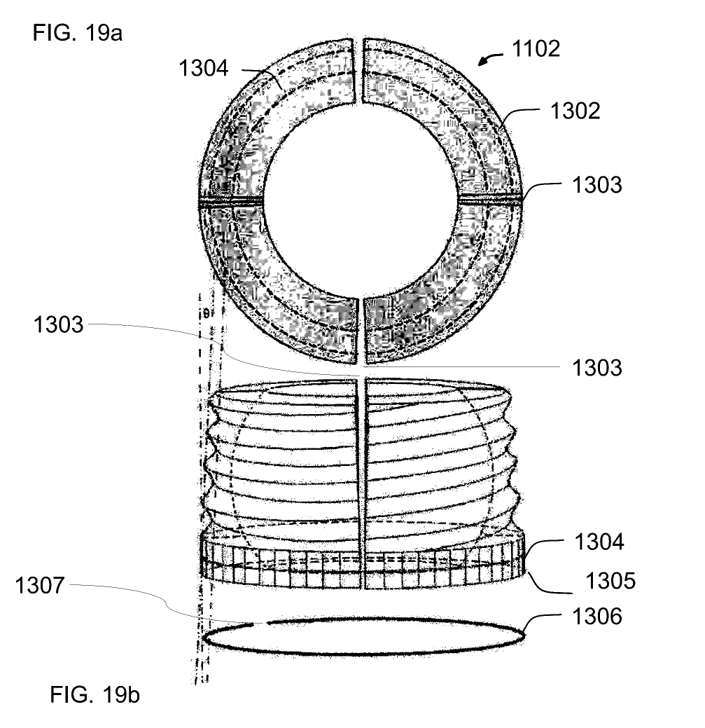

An exemplary fastening bolt 1102, configured to be a mating partner with the fastening nut 1101 is depicted in FIGS. 19a and 19b. From a top view, the fastening bolt 1102 comprises a first part 1301 and a second part 1302, and the first part 1301 and second part 1302 is separated by at least one fastening gap 1303. The first part 1301 and second part 1302 are configured to be placed inside of the fastening nut 1101 together to provide a lock or release for the retaining member 1103. When the first and second part of fastening bolt (1301 and 1302) are brought closer to reduce the fastening gap 1303, the retaining member 1103 begins to be locked in one pasture. When the first and second part of fastening bolt (1301 and 1302) are in a relaxed position and the fastening gap 1303 is not reduced or decreased, then the retaining member 1103 is movable with the fastening bolt 1102.

FIG. 19b specifically identifies the structure units that work together to adjust the fastening gap 1303 and how a lock and unlock position of the retaining member 1103 is accomplished by simply adjusting the fastening bolt 1102. The fastening bolt 1102 further comprises a holding handle for the fastening bolt 1305, which allows the fastening bolt 1102 adjust its relative position with respect to fastening nut 1101 manually. Additionally the fastening bolt 1102 further comprises a clamp ring 1306, which is designed to be placed on a holder of the clamp ring 1304, which is located on the exterior of the holding handle for the fastening bolt 1305. The clamp ring 1304 has an opening 1307, which is about the combination of the fastening gaps, if there is more than one fastening gap. When the first and second part of the fastening bolts 1301 and 1302 are brought together, the clamp ring 1304 is used to hold the two parts together. As the fastening bolt 1102 moves in a first direction in the fastening nut 1101, the clamp ring 1304 is squeezed and the opening of the clamp ring 1307 is reduced, as a result, the fastening gap 1303 between the first and second part (1301 and 1302) of the fastening bolt 1102 is also reduced and the retaining member 1103 begins to be locked. When the retaining member 1103 is completely locked in the fastening nut 1101, the two pieces of the fastening bolt (1301 and 1302) meet at an inclination angle of θ. When the fastening bolt 1102 moves in an opposite direction of the first direction, the pressure applied to the clamp ring 1306 by the fastening nut 1101 is reduced, and the opening of the clamp ring 1307 begins to return to its original position and as a result, the two pieces of the fastening bolt 1301 and 1302 begin to revert back to their original position and the retaining member 1103 begins to unlock. In other words, when the retaining member 1103 is in an unlocked position, the two pieces of the fastening bolt 1301 and 1302 are not clamped together by the clamp ring 1306.

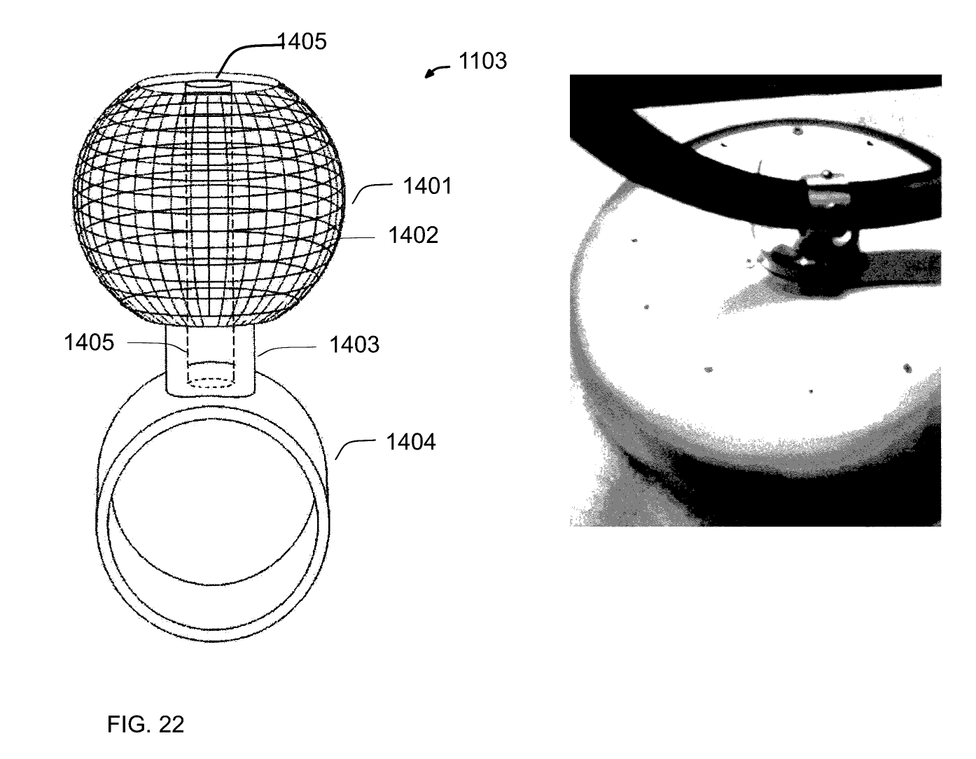

FIG. 22 illustrates a detailed structure of the retaining member 1103, which comprises a ball shaped first end 1401 and a ring shaped second end 1404, the first end and the second end are connected by a connecting neck 1403. When the retaining member 1103 is assembled inside the fastening bolt 1102 as shown in FIGS. 21 and 22, the ball shaped first end 1401 is partially exposed outside of the bottom surface of the solar cell assembly. And the connecting neck 1403 and the ring shaped second end 1404 are exposed outside of the solar cell assembly. The solar cell assembly is connected to lamp holder 101 by the ring shaped second end 1404. The wires extended from the control circuit board 501 pass through a through hole 1405, which pass through from the ball shaped first end 1401 to the ring shaped second end 1404, and enters into the lamp holder 101 and arrives at the LED units. The ball shaped first end of the retaining member 1401 further comprises groves 1402, which helps to retain the ball shaped first end of the retaining member 1103. When the ball shaped first end of the retaining member 1401 is locked in the fastening nut 1101, the attachment assembly 106 is locked in one pasture; correspondingly the solar cell assembly is locked and maintained in one orientation. As the fastening bolt 1102 moves in the fastening nut 1101 to unlock the ball shaped first end of the retaining member 1401, the ball shaped first end of the retaining member 1401 can rotate within the fastening nut 1101, either in a clockwise direction or in a counter clockwise direction. Once a desirable pasture of the retaining member 1103 is achieved, the retaining member 1103 is locked again in the fastening nut 1101 by the fastening bolt 1102.

In another aspect of the present invention, a method of using a solar lighting device is described. The method comprises:

providing a solar panel locked in one orientation;

adjusting the orientation of the solar panel in accordance with a direction of sunlight, comprising

touching a top surface of the solar panel to rotate the solar panel counter clockwise; or

touching the top surface of the solar panel to rotate the solar panel clockwise.

Further, the solar panel 401 is attached to the solar lighting device through an attachment assembly 106, which comprises a fastening nut 1101, fastening bolt 1102 and a retaining member 1103, wherein the fastening bolt 1102 is capable to adjust a pasture of the retaining member 1103 to unlock and lock the orientation of the solar panel 401.

Further when the solar panel 401 rotates clockwise or counter clockwise, the fastening nut 1101 and fastening bolt 1102 move around a spherical surface of the retaining member 1103.

By moving the fastening bolt 1102 inside the fastening nut 1101, back and forth, (inventor also includes left and right, but I don't believe the bolt can move left and right in a nut), the ball shaped first end of the retaining member 1401 is lock and unlocked within the fastening nut. Because the fastening nut and bolt can further move along a spherical surface of the ball shaped first end of the retaining member 1401, the ring shaped second end of the retaining member 1404 is fixed within the lamp holder 101, the orientation of the solar panel 401 in the solar lamp described in the present invention, can be adjusted and locked in possibly any and all directions very easily.

In the foregoing descriptions, in one orientation of the solar cell assembly, the connecting neck and the top surface of the solar cell forms an angle a. When the angle changes, this means the solar cell assembly has changed its orientation. Similarly, in one pasture of the attachment assembly 106, the height direction of the fastening nut 1101 forms an angle b with the connecting neck 1403, when angle b changes, a pasture of the attachment assembly 106 changes.

In the foregoing descriptions, the elements referred are
100 one exemplary embodiment of the solar lamp
101 lamp holder or holder for the light device
102 lamp base
103 cover for LEDs
104 solar disk
105 LEDs or LED units
106 attachment assembly
401 solar panel(s)
402 solar sensor
403 sunlight window glass
501 control circuit board
504 battery
1101 fastening nut
1102 fastening bolt
1103 retaining member
1301 a first part of bolt
1302 a second part of bolt
1303 fastening gap
1304 holder for a clamp ring
1305 holding handle for the fastening bolt
1306 clamp ring
1307 opening for the clamp ring
1401 ball shaped first end of the retaining member
1402 hollow grooves to retain pressure for the fastening bolt
1403 connecting neck
1404 ring shaped second end of the retaining member
1405 through hole for wire passage

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not meant to be exhaustive or to limit the embodiments to the precise forms disclosed. It will be apparent to one of ordinary skill in the art that many modifications and variations are possible in view of the above teachings.

The advantages of the embodiments described are numerous. Different aspects, embodiments or implementations can yield one or more of the following advantages. Many features and advantages of the present embodiments are apparent from the written description and, thus, it is intended by the appended claims to cover all such features and advantages of the invention. Further, since numerous modifications and changes will readily occur to those skilled in the art, the embodiments should not be limited to the exact construction and operation as illustrated and described. Hence, all suitable modifications and equivalents can be resorted to as falling within the scope of the invention.

1. A solar lighting device, comprising:
a housing, comprised of an elongated lighting device holder and a cover for a plurality of LEDs; and
a solar cell assembly, attached to the elongated lighting device holder through an attachment assembly, comprising:
a solar panel situated on a top surface of the solar cell assembly; and
an attachment assembly, configured to adjust an orientation of the solar panel to harvest more sun light by changing a pasture of the attachment assembly, and wherein the pasture of the attachment assembly is changed by a rotation.

2. The solar lighting device of claim 1, wherein the housing further comprises a base allowing the solar lighting device to be mounted on a surface.

3. The solar lighting device of claim 2, wherein the surface that the solar lighting device is to be mounted on is a surface of a sidewall.

4. The solar lighting device of claim 1, wherein the solar cell assembly is substantially half dome shaped, and the top surface of the solar cell is flat and the bottom surface of the solar cell is curved.

5. The solar lighting device of claim 1, wherein the elongated lighting device holder has a top.

6. The solar lighting device of claim 1, wherein the solar cell assembly is attached at the top of the lighting device holder.

7. The solar lighting device of claim 1, wherein the solar assembly further comprises a control circuit board and a plurality of rechargeable batteries.

8. The solar lighting device of claim 7, wherein the control circuit board and the plurality of rechargeable batteries are sandwiched between the top surface and the bottom surface of the solar cell assembly.

9. The solar lighting device of claim 1, wherein the solar cell assembly further comprises a solar sensor, situated on the top surface of the solar cell assembly, detecting the brightness of the incoming sunlight and for automatically turning the device ON/OFF.

10. The solar lighting device of claim 1, wherein the solar sensor is placed is close proximity to an edge of the top surface.

11. The solar lighting device of claim 1 wherein the lighting device is a standalone unit.

12. The solar lighting device of claim 1, wherein a first end of the attachment assembly is embedded in the bottom surface of the solar cell assembly.

13. The solar lighting device of claim 1, wherein the attachment assembly comprises
a fastening nut, one portion of the fastening nut is embedded in the bottom surface of the solar cell assembly and the other portion of the fastening nut being exposed outside of the bottom surface of the solar cell assembly;
a fastening bolt, configured to be a mating partner with the fastening nut, comprises a first part and a second part, the first part and second part separated by a fastening gap; and
a retaining member, having a ball shaped first end, wherein the fastening bolt moves inside of the fastening nut in one direction, the fastening gap is reduced, the ball shaped first end of the retaining member is maintained in the fastening bolt by a static pressure in a locked position; and whereas when the fastening gap is not reduced, the ball shaped first end of the retaining member can rotate within the fastening bolt in an unlocked position.

14. The solar lighting device of claim 12, wherein the fastening bolt further comprises a holding handle for the fastening bolt, which emerges outside of the bottom surface of the solar cell assembly.

15. The solar lighting device of claim 12, wherein the fastening bolt further comprises a clamp ring, configured to be placed on the exterior of the fastening bolt holding handle, and the clamp ring has an opening.

16. The solar lighting device of claim 12, wherein the retaining member comprises a second end, which is substantially a ring structure, configured to be attached onto the elongated lighting device holder.

17. The solar lighting device of claim 16, wherein the retaining member further comprises a connecting member between the ball shaped first end and ring shaped second end, and the connecting member has a through hole allowing a wire extended from the control circuit board to pass therethrough.

18. The solar lighting device of claim 12, wherein the ball shaped first end of the retaining member has a through hole, which is connected to the through hole in the connecting member.

19. The solar lighting device of claim 12, wherein the ball shaped first end of the retaining member has hollow grooves to retain static pressure for the fastening bolt.

20. A method to use a solar lighting device, comprising
providing a solar panel locked in one orientation by locking an attachment assembly in one pasture;
adjusting the orientation of the solar panel in accordance with a direction of sunlight, comprising
touching a top surface of the solar panel to rotate the solar panel counter clockwise; or
touching the top surface of the solar panel to rotate the solar panel clock wise.

21. The method of claim 20, wherein the attachment assembly comprises a fastening nut, fastening bolt and a retaining member, wherein the fastening bolt is capable to adjust the pasture of the retaining member to unlock and lock an orientation of the solar panel.
